(19) United States
(12) Patent Application Publication
(10) Pub. No.: US 2026/0236539 A1
(43) Pub. Date: Aug. 13, 2026

(54) GLOBAL MACHINE LEARNING MODEL FOR ENTITY MATCHING USING LLM-BASED AGENTS

(71) Applicant: SAP SE, Walldorf (DE)

(72) Inventor: Yi Quan Zhou, Singapore (SG)

(21) Appl. No.: 19/049,055

(22) Filed: Feb. 10, 2025

(51) Int. Cl. G06F 16/93; G06F 18/22

(52) U.S. Cl. CPC G06F 16/93; G06F 18/22

(57) ABSTRACT

Methods, systems, and computer-readable storage media for receiving, by a first LLM-based agent, a data schema description, a task description, and a set of examples, prompting, by the first LLM-based agent, a first LLM using a first prompt that is provided based on the data schema description, the task description, and the set of examples, the first LLM returning a set of metrics responsive to the first prompt, filtering data from a query document and data from a target document using the set of metrics, prompting, by a second LLM-based agent, a second LLM using a second prompt that is provided based on unstructured data of the query document, the second LLM returning a set of property-value pairs responsive to the second prompt, providing a merged query document, and processing the merged query document and the target document using a global ML model to generate a set of results.

### BACKGROUND

Enterprises continuously seek to improve and gain efficiencies in their operations. To this end, enterprises employ software systems to support execution of operations. Recently, enterprises have embarked on the journey of so-called intelligent enterprise, which includes automating tasks executed in support of enterprise operations using machine learning (ML) systems. For example, one or more ML models are each trained to perform some task based on training data. Trained ML models are deployed, each receiving input (e.g., a computer-readable document) and providing output (e.g., classification of the computer-readable document) in execution of a task (e.g., document classification task). ML systems can be used in a variety of problem spaces. An example problem space includes autonomous systems that are tasked with matching items of one entity to items of another entity. Examples include, without limitation, matching questions to answers, people to products, bank statements to invoices, and bank statements to customer accounts.

### SUMMARY

Implementations of the present disclosure are directed to training and deploying a global machine learning (ML) model for entity matching. More particularly, implementations of the present disclosure are directed to using a set of agents that leverage one or more large language models (LLMs) to train and deploy a global ML model for entity matching.

In some implementations, actions include receiving, by a first LLM-based agent, a data schema description, a task description, and a set of examples, prompting, by the first LLM-based agent, a first LLM using a first prompt that is provided based on the data schema description, the task description, and the set of examples, the first LLM returning a set of metrics responsive to the first prompt, filtering data from a query document and data from a target document using the set of metrics, prompting, by a second LLM-based agent, a second LLM using a second prompt that is provided based on unstructured data of the query document, the second LLM returning a set of property-value pairs responsive to the second prompt, providing a merged query document based on the property-value pairs, and processing the merged query document and the target document using a global ML model to generate a set of results. Other implementations of this aspect include corresponding systems, apparatus, and computer programs, configured to perform the actions of the methods, encoded on computer storage devices.

These and other implementations can each optionally include one or more of the following features: the set of metrics includes data fields determined to be relevant to a task executed by the global ML model; actions further include splitting data of the query document into a first sub-set and a second sub-set, the first sub-set including structured data, and the second sub-set including the unstructured data; the query document records structured data and unstructured data and the merged query document records only structured data; actions further include receiving, by the second LLM-based agent, the data schema description and the task description, the second prompt further being provided based on the data schema description and the task description; actions further include maintaining an unstructured data mapping based on responses from the second LLM for training of the global ML model; the second prompt is further provided based on the unstructured data mappings for inference using the global ML model; the processing the merged query document and the target document using a global ML model to generate a set of results is executed for training of the global ML model; and the processing the merged query document and the target document using a global ML model to generate a set of results is executed for inference using the global ML model after training of the global ML model.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example architecture that can be used to execute implementations of the present disclosure.

FIG. 2 depicts portions of example electronic documents.

FIG. 3A depicts an example conceptual architecture for training in accordance with implementations of the present disclosure.

FIG. 3B depicts an example conceptual architecture for inference in accordance with implementations of the present disclosure.

FIGS. 4A and 4B depict example processes that can be executed in accordance with implementations of the present disclosure.

FIG. 5 is a schematic illustration of example computer systems that can be used to execute implementations of the present disclosure.

Like reference symbols in the various drawings indicate like elements.

### DETAILED DESCRIPTION

Implementations of the present disclosure are directed to training and deploying a global machine learning (ML) model for entity matching. More particularly, implementations of the present disclosure are directed to using a set of agents that leverage one or more large language models (LLMs) to train and deploy a global ML model for entity matching.

Implementations can include actions of receiving, by a first LLM-based agent, a data schema description, a task description, and a set of examples, prompting, by the first LLM-based agent, a first LLM using a first prompt that is provided based on the data schema description, the task description, and the set of examples, the first LLM returning a set of metrics responsive to the first prompt, filtering data from a query document and data from a target document using the set of metrics, prompting, by a second LLM-based agent, a second LLM using a second prompt that is provided based on unstructured data of the query document, the second LLM returning a set of property-value pairs responsive to the second prompt, providing a merged query document based on the property-value pairs, and processing the merged query document and the target document using a global ML model to generate a set of results.

Implementations of the present disclosure are described in further detail with reference to an example problem space that includes matching entities represented in computer-readable files. For example, the problem space can include determining matches between records (recorded in line items) of a bank statement table and records (recorded in line items) of an invoice table, each of which is stored in a respective computer-readable file. In this non-limiting example, each row (line item) of the bank statement table is an entity (also referred to as query item) that represents a deposit to a bank account, and each row (line item) of the invoice table is an entity (also referred to as target item) that represents an invoice. In this non-limiting example, an autonomous system leverages a global ML model to match a query item of the bank statement table to one or more target items of the invoice table. In this manner, the autonomous system can reconcile invoices to payments to clear invoices.

It is appreciated that implementations of the present disclosure are described in further detail herein with reference to the example problem space for purposes of illustration. It is contemplated, however, that implementations of the present disclosure can be realized in any appropriate problem space (e.g., matching questions to answers, people to products, bank statements to customer accounts, matching redundant data between databases).

Implementations of the present disclosure are described in further detail herein with reference to an example application that leverages one or more ML models to provide functionality (referred to herein as a ML application). The example application includes SAP Cash Application (CashApp) provided by SAP SE of Walldorf, Germany. CashApp leverages ML models (e.g., generic line-item matching (GLIM) models) that are trained using a ML architecture (e.g., SAP AI Core) to learn accounting activities and to capture rich detail of customer and country-specific behavior. An example accounting activity can include matching payments indicated in a bank statement to invoices for clearing of the invoices (open invoices). For example, using an enterprise platform (e.g., SAP S/4 HANA), incoming payment information (e.g., recorded in computer-readable bank statements) and open invoice information are passed to a matching engine, and, during inference, one or more GLIM models predict matches between records of a bank statement and invoices. In some examples, matched invoices are either automatically cleared (auto-clearing) or suggested for review by a user (e.g., accounts receivable). Although CashApp is referred to herein for purposes of illustrating implementations of the present disclosure, it is contemplated that implementations of the present disclosure can be realized with any appropriate application that leverages one or more ML models.

As introduced above, enterprises continuously seek to improve and gain efficiencies in their operations. To this end, enterprises employ software systems to support execution of operations. Recently, enterprises have embarked on the journey of so-called intelligent enterprise, which includes automating tasks executed in support of enterprise operations using ML systems. For example, one or more ML models are each trained to perform some task based on training data. Trained ML models are deployed, each receiving input (e.g., a computer-readable document) and providing output (e.g., classification of the computer-readable document) in execution of a task (e.g., document classification task). ML systems can be used in a variety of problem spaces. An example problem space includes autonomous systems that are tasked with matching items of one entity to items of another entity. Examples include, without limitation, matching questions to answers, people to products, bank statements to invoices, and bank statements to customer accounts.

The problem of matching entities represented by computer-readable records (electronic documents) appears in many contexts. Example contexts can include matching product catalogs, deduplicating a materials database, and matching incoming payments from a bank statement table to open invoices. Implementations of the present disclosure are described in further detail with reference to an example problem space that includes the domain of finance and matching bank statements to invoices. More particularly, implementations of the present disclosure are described with reference to the problem of, given a bank statement (e.g., a computer-readable electronic document recording data representative of a bank statement), enabling an autonomous system using a ML model to determine one or more invoices (e.g., computer-readable electronic documents recording data representative of one or more invoices) that are represented in the bank statement. It is contemplated, however, that implementations of the present disclosure can be realized in any appropriate problem space.

Technologies related to ML have been widely applied in various fields. For example, ML-based decision systems can be used to make decisions on subsequent tasks. With reference to the example context, an ML-based decision system can be used to determine matches between bank statements and invoices. For example, invoices can be cleared in an accounting system by matching invoices to one or more line items in bank statements. In other contexts, decisions on treatment courses of patients (e.g., prescribe/not prescribe a drug) and/or decisions on whether to approve customers for loans can be made based on output of ML-based decision systems. In general, an output of a ML-based decision system can be referred to as a prediction or an inference result. However, the use of ML model in decision systems present unique challenges that did not previously exist in the pre-ML world.

For example, enterprise systems often need to match items (query items) from one table to one or more items (target items) in another table within a database system. Matching is based on inherent relationships within the data. For certain documents, such as tables, this can be referred to as line-item matching. A ML model, referred to as a GLIM model, can be employed to achieve this matching task. For example, a GLIM model is provided as a classifier that is trained to predict entity pairs to a fixed set of class labels (\vec{1}) (e.g., l₀, l₁, l₂). For example, the set of class labels (\vec{l}) can include ‘no match’ (l₀), ‘single match’ (l₁), and ‘multi match’ (l₂). In some examples, the ML model is provided as a function ƒ that maps a query entity (\vec{a}) and a target entity (\vec{b}) into a vector of probabilities (\vec{p}) (also called ‘confidences’ in the deep learning context) for the labels in the set of class labels. This can be represented as:

$$f ( \vec{a} , \vec{b} ) = ( \begin{matrix}{p}_{0} \\ {p}_{1} \\ {p}_{2}\end{matrix} )$$

where \vec{p}={p₀, p₁, p₂}. In some examples, p₀ is a prediction probability (also referred to herein as confidence c) of the item pair \vec{a}, \vec{b} belonging to a first class (e.g., no match), p₁ is a prediction probability of the item pair \vec{a}, \vec{b} belonging to a second class (e.g., single match), and p₂ is a prediction probability of the item pair \vec{a}, \vec{b} belonging to a third class (e.g., multi match).

Here, p₀, p₁, and p₂ can be provided as numerical values indicating a likelihood (confidence) that the item pair a, b belongs to a respective class. In some examples, the ML model can assign a class to the item pair d, b based on the values of p₀, p₁, and p₂. In some examples, the ML model can assign the class corresponding to the highest value of p₀, p₁, and p₂. For example, for an entity pair a, b, the ML model can provide that p₀=0.13, p₁=0.98, and p₂=0.07. Consequently, the ML model can assign the class ‘single match’ (l₁) to the item pair \vec{a}, \vec{b}.

In general, GLIM models are robust when data relations can be abstracted from training data used to train the GLIM models and the data relations are consistent during inference. However, for real-world scenarios, data relations cannot always be abstracted from the training data and can be different during inference. For example, data tables used for matching can include multiple fields (e.g., columns) that are irrelevant to the task of matching. When using such data tables for training, a significantly large volume of training data is required to enable the GLIM model to differentiate and abstract data fields that are relevant to matching from data fields that are irrelevant to matching.

By way of non-limiting example, a field PARTNERBANK in a bank statement table is an intermediate bank involved in fund transactions within a banking system and is irrelevant to matching bank statement line items to invoice line items. As another non-limiting example, a field DOCUMENTREFERENCEID is a reference number for a bank statement document used for abstracting the data of the bank statement. Because it is just a property related to an operation in a system process, it is also irrelevant to matching bank statement line items to invoice line items.

Accordingly, some data within documents inject noise into training of ML models, because the training process takes all of the data as potential properties of matching relations. When the volume of training data is not large enough, the ML model cannot differentiate irrelevant data from relevant data for the matching task. Prior to training, it can be difficult to determine the volume of training data that would be needed to enable the ML model to learn and differentiate the noisy data.

Further, during inference after training, if inference data (e.g., the data to be processed for a matching task) does not represent data relations that are consistent with the data relations represented in the training data, performance of the ML model degrades and can degrade to such a point that the inference results are unusable. By way of non-limiting example, training data used to train a ML model can be specific to a first enterprise and represent data relations existing in operations of the first enterprise (e.g., between the first enterprise and its vendors). A second enterprise can include inference data that represents data relations existing in operations of the second enterprise (e.g., between the second enterprise and its vendors). If the ML model were to be used to execute a matching task for the inference data of the second enterprise, the inference results would be so inaccurate as to be unusable. That is, the ML model is specific to the data relations of the first enterprise and is ineffective to execute inference for the second enterprise.

As such, traditional approaches require a ML model to be developed, trained, and maintained for each enterprise. That is, training data needs to be provided for each enterprise (in sufficiently large volumes, as discussed above), training executed for each enterprise, and the resulting ML models stored and maintained for each enterprise. As such, technical resources (e.g., processing, memory) consumed for developing, training, and maintaining a ML model is multiplied across all enterprises needing a ML model.

In view of the above context, implementations of the present disclosure provide for training and inference of a global ML model that can be used with inference data representing disparate data relations. More particularly, and as described in further detail herein, implementations of the present disclosure provide a set of LLM-based agents that can be used to understand data fields in the context of domain knowledge and filter out data fields determined to be irrelevant to entity matching. In this manner, a volume of the data to be processed for training and/or inference is decreased as only those data fields determined to be relevant to entity matching remain. Further, and as described in further detail herein, a ML model (e.g., GLIM model) can be trained with a relatively small, but efficient set of training data. This not only conserves technical resources, but also improves performance of the ML model, as compared to traditional approaches. Also, and as described in further detail herein, implementations of the present disclosure provide the ML model as a global ML model that can be used across multiple, disparate sets of inference data (e.g., inference data of multiple enterprises).

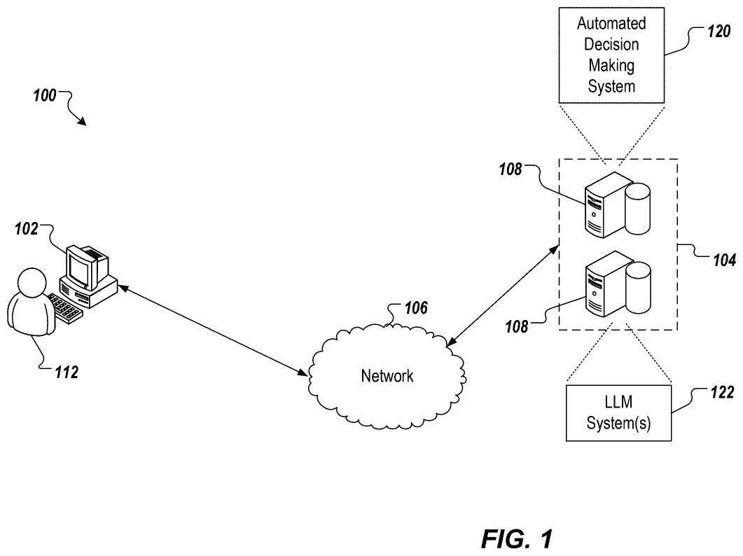

FIG. 1 depicts an example architecture 100 in accordance with implementations of the present disclosure. In the depicted example, the example architecture 100 includes a client device 102, a network 106, and a server system 104. The server system 104 includes one or more server devices and databases 108 (e.g., processors, memory). In the depicted example, a user 112 interacts with the client device 102.

In some examples, the client device 102 can communicate with the server system 104 over the network 106. In some examples, the client device 102 includes any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. In some implementations, the network 106 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems.

In some implementations, the server system 104 includes at least one server and at least one data store. In the example of FIG. 1, the server system 104 is intended to represent various forms of servers including, but not limited to a web server, an application server, a proxy server, a network server, and/or a server pool. In general, server systems accept requests for application services and provides such services to any number of client devices (e.g., the client device 102 over the network 106).

In accordance with implementations of the present disclosure, the server system 104 can host a ML-based automated decision-making system 120 that predicts matches between entities (e.g., CashApp, referenced by way of example herein) and automatically executes one or more tasks based on the predicted matches. As described in further detail herein, the ML-based automated decision-making system 120 leverages one or more LLMs executed within one or more LLM systems 122 to train a global ML model and deploy the global ML model for inference. In some examples, the one or more LLMs of the one or more LLM systems 122 can be provided by one or more third-parties (e.g., GPT-4 provided by OpenAI).

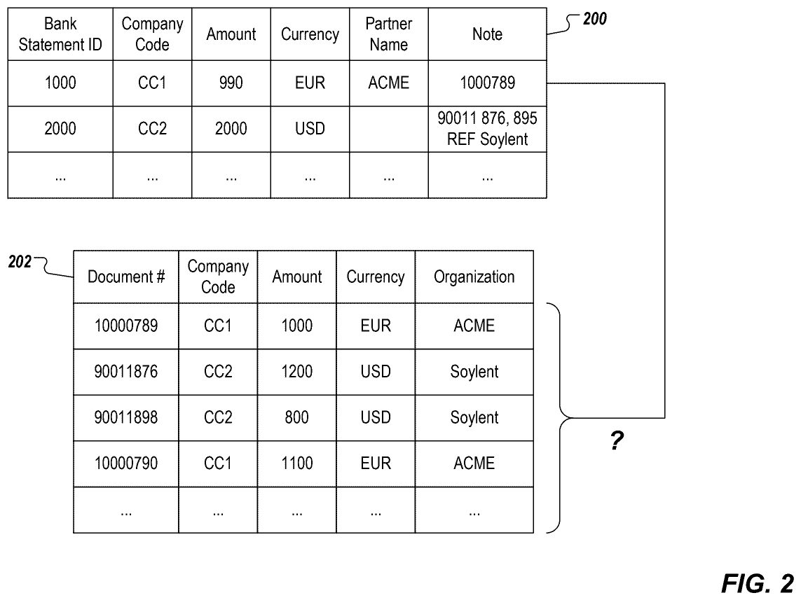

In the example context, FIG. 2 depicts portions of example electronic documents. In the example of FIG. 2, a first electronic document 200 includes a bank statement table that includes records (line items) representing payments received, and a second electronic document 202 includes an invoice table that includes invoice records (line items) respectively representing invoices that had been issued. In the example context, each bank statement record (as a query item) is to be matched to one or more invoice records (as target items). Accordingly, the first electronic document 200 and the second electronic document 202 are processed using a ML model (e.g., a global ML model) that provide predictions regarding matches between a bank statement record (query item) and one or more invoice records (target items) (e.g., using CashApp, as described above).

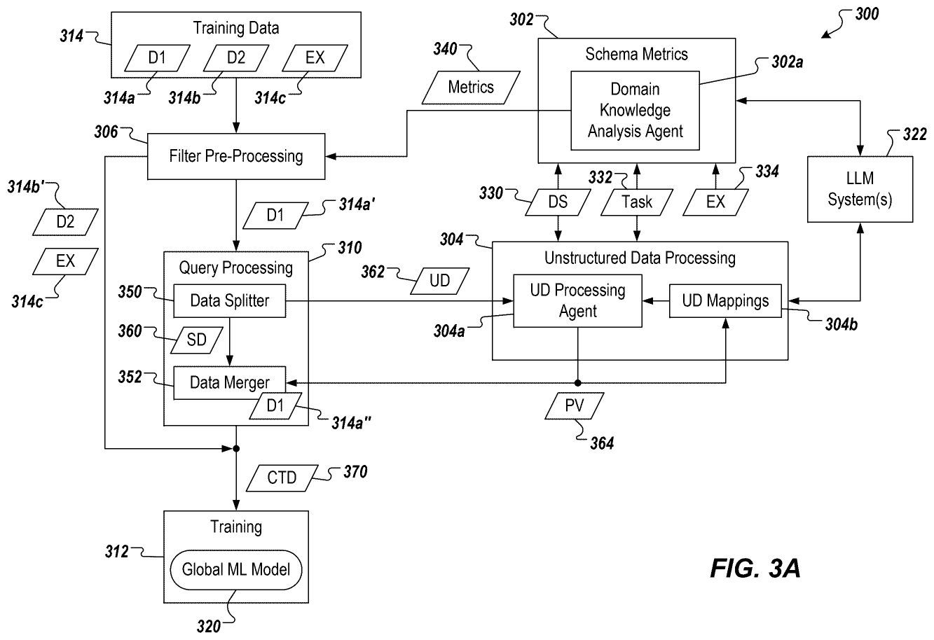

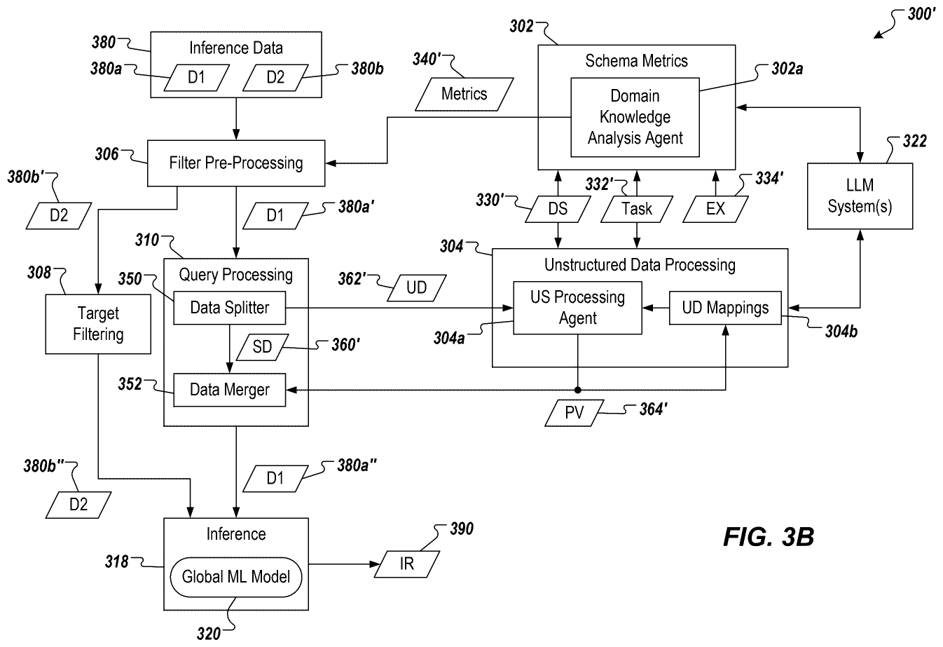

FIG. 3A depicts an example conceptual architecture 300 for training in accordance with implementations of the present disclosure. In the example of FIG. 3A, the conceptual architecture 300 includes a schema metrics module 302, an unstructured data processing module 304, a filter pre-processing module 306, a query processing module 310, and a training module 312. As described in further detail herein, at least a portion of training data 314 is used to train a global ML model 320 (e.g., a GLIM model).

In further detail, the schema metrics module 302 executes a domain knowledge analysis agent 302a that leverages a LLM of one or more LLM systems 322 (e.g., GPT-4 provided by OpenAI). As such, the domain knowledge analysis agent 302a can be referred to as a LLM-based agent. In some examples, the domain knowledge analysis agent 302a is provided as a conversational agent that a user can converse with in natural language. An example conversational agent can include Joule provided by SAP SE of Walldorf, Germany. For example, a user that seeks to train the global ML model 320 can converse with the domain knowledge analysis agent 302a to input data, request execution of tasks, and receive output.

In some examples, the domain knowledge analysis agent 302a functions to leverage domain knowledge to enable data fields determined to be irrelevant to the matching task to be filtered from the training data 314. More particularly, the domain knowledge analysis agent 302a can receive a data schema description 330, a task description 332, and a set of example matches 334 that are collectively descriptive of the matching task and data that is to be matched. As described in further detail herein, the domain knowledge analysis agent 302a prompts the one or more LLM systems 322 based on the data schema description 330, the task description 332, and the set of example matches 334 to provide a set of metrics 340. In some examples, the set of metrics 340 can include a list of data fields (which can be referred to as global ML model schema metrics) that are relevant to the matching task. In some examples, the set of metrics 340 includes one or more data fields of a query document (e.g., bank statement table) and one or more data fields of a target document (e.g., invoice table).

In some examples, the data schema description 330 provides a description of the data schema of the query document and a data schema of the target document for the matching task. In the non-limiting context of matching line items of a bank statement table to one or more line items of an invoice table, the following example data schema description 330 can be provided:
Table Schema:
Rows in Table 1 are payment items and Rows in Table 2 are the invoices. The following is the schema for the Tables:
Table 1:
MEMOLINE: Free form text denoting the payment information
AMOUNTINTRANSACTIONCURRENCY: Numeric value denoting amount of money paid
Table 2:
AMOUNTINTRANSACTIONCURRENCY: Numeric value denoting the amount of money to be paid or the invoice amount
ORGANIZATIONBPNAMEL: Text value denoting a customer name
ACCOUNTING DOCUMENT: Numeric value denoting a invoice number

### Listing 1: Example Data Schema Description

In some examples, the task description 332 provides a description of the task, such as the entity matching task, that is to be executed. In this sense, the task description 332 describes the objective of data relation identification for the LLM system(s) 322. As such, the task description 332 gives context of the domain to instruct the LLM(s) to perform as a professional within the domain. In the non-limiting context of matching line items of a bank statement table to one or more line items of an invoice table, the following example task objective can be provided in the task description 332:
Task Objective:
For the Vendor identify matching items or invoices in Table 2 corresponding to items or payments in Table 1

### Listing 2: Example Task Objective

In some examples, the task description 332 can also include a process description that describes a process (e.g., executed by an enterprise) that the task is executed for. In the non-limiting context of matching line items of a bank statement table to one or more line items of an invoice table, the following example process description can be provided in the task description 332:
Enterprise Process:
A Vendor provides services or sells products to multiple customers for which the Vendor issues invoices to those customers to make payments. Customers make payments for those invoices. Any given customer can make payments for multiple invoices in 1 single payment of the total amount of invoices or make 1 payment for each of the invoices with corresponding amount.

### Listing 3: Example Process Description

In some examples, the set of example matches 334 provides examples of matching relations between data fields (data attributes) of the query document and the target document. This can include a description of specific relation types (e.g., 1-to-1, 1-to-many) and matching data. In the non-limiting context of matching line items of a bank statement table to one or more line items of an invoice table, the following example set of example matches 334 can be provided:

Examples:
Below shows examples of matching items between rows in Table 1
and rows in Table 2 in csv format. The matching can be 1 row
in Table 1 matching 1 row in Table 2 or 1 row in Table 1
matching multiple rows in Table 2.
Example 1 shows the case of matching of 1 row in Table 1 to 2
rows in Table 2. ′MEMOLINE′ of Row 1 in Table 1 contains
′1800034956 34932′ which are the same as the ′1800034956′ and
′1800034932 ′ as ′ACOUNTINGDOCUMENT′ of Row 1 and Row 2 in
Table 2. ′ MEMOLINE′ of Row 1 in Table 1 also contains
′Hamburg′ which are the same as the ′Hamburg Mall′ for
′0RGANIZATIONBPNAMEl′ of Row 1 and Row 2 in Table 2.
′AMOUNTINTTRANSACTIONCURRENCY′ of Row 1 in Table 1 is ′ 95.00′
which is the total amount of ′75.00′ and ′17.00′ as
′AMOUNTINTTRANSACTIONCURRENCY′ of Row 1 and Row 2 in Table 2.
So ′MEMOLINE′, ′AMOUNTINTTRANSACTIONCURRENCY′ in Table 1 and
′AMOUNTINTTRANSACTIONCURRENCY′, ′ORGANIZATIONBPNAME1′,
′ACOUNTINGDOCUMENT′ in Table 2 are necessary attributes for
identifying matching relations.
Example 2 shows 1 row in Table 1 matching 1 row in Table 2.
′MEMOLINE′ of Row 1 in Table 1 contains ′800034022′ which is
the same as the ′1800034022′ as ′ACOUNTINGDOCUMENT′ of ROW 1
in Table 2. ′AMOUNTINTTRANSACTIONCURRENCY′ of Row 1 in Table 1
is ′22.00′ which is the same as ′AMOUNTINTTRANSACTIONCURRENCY′
of Row 1 in Table 2. So ′MEMOLINE′,
′AMOUNTINTTRANSACTIONCURRENCY′ in Table 1 and
′AMOUNTINTTRANSACTIONCURRENCY′, ′ACOUNTINGDOCUMENT′ in Table 2
are necessary attributes for identifying matching relations.
Example 1:
Table 1:
′MEMOLINE′ , ′AMOUNTINTTRANSACTIONCURRENCY′
1800034956 34932 Hamburg, 95.00
Table 2:
′AMOUNTINTTRANSACTIONCURRENCY′, ′ORGANIZATIONBPNAME1′,
′ACOUNTINGDOCUMENT ′
78.00, Hamburg Mall, 1800034956
17.00, Hamburg Mall, 1800034932
Example 2:
Table 1:
′MEMOLINE′, ′AMOUNTINTTRANSACTIONCURRENCY′
800034022, 22.00
Table 2:
′AMOUNTINTTRANSACTIONCURRENCY′, ′ORGANIZATIONBPNAME1′,
′ACOUNTINGDOCUMENT′
22.00, Computer Systems (DE), 1800034022

### Listing 4: Example Set of Example Matches

In accordance with implementations of the present disclosure, the domain knowledge analysis agent 302a prompts the LLM system(s) 322 using a prompt, the LLM system(s) processes the prompt and returns the set of metrics 340. In some examples, the prompt is constructed to enable the LLM(s) to identify and abstract data fields that are relevant to the matching task from the query document and the target document. In some examples, the prompt can be provided as a chain-of-thought (CoT) prompt. In some examples, the prompt instructs the LLM to do the analysis in multiple steps. For example, a first step can include identifying the data fields relevant for enterprise task (e.g., account reconciliation between bank statement and open invoices), and a second step can include identifying the data fields among the result of the first step, which are useful in identify the matching relations. In the non-limiting context of matching line items of a bank statement table to one or more line items of an invoice table, the following example prompt can be provided:

```
You are an accountant to reconcile bank statement item and
open invoices item. You evaluate the data table schemas of
bank statement and open invoice to identify the attribute
items in 2 tables which are relevant to form matching
relations in terms of reconciliation with below steps:
1. Understand the data table schemas of bank statement table
{BankStatementDataSchema} and open invoices table
{OpeninvoiceDataSchema} based on the task objective
{TaskObjective} and enterprise process {EnterpriseProcess}.
2. Look for the attribute items in bank statement table schema
and open invoices data schemas which relevant to details of
payment transaction for an invoice, Output the identified
attributes to {OutputDataSchema} in JSON format as:
′{
  bs: {
    ...
  },
  iv: {
    ...
  }
}′
```

3. Use matching samples {SampleMatching} to validate the identified attributes of bank statement {OutputDataSchema} in the context of the original data table schemas of bank statement and open invoices and add any missing attribute into output for bank statement and open invoices respectively.

### Listing 5: Example Prompt

In this context, an example set of metrics 340 can be provided as:

```
{
  Query: {
    Mapping Attributes: [
      COMPANYCODE,
      COUNTRYKEY,
      HOUSEBANK,
      HOUSEBANKACCOUNT,
      CURRENCY,
      AMOUNTINTRANSACTIONCURRENCY,
      FISCAL YEAR,
      DEBITCREDITCODE,
      BUSINESSPARTNERNAME,
      BANKSTATEMENTKEY
    ],
    Unstructured Attributes: [
      MEMOLINE
    ]
  },
  Target: {
    Mapping Attributes: [
      COMPANYCODE,
      COUNTRYKEY,
      HOUSEBANK,
      HOUSEBANKACCOUNT
      CURRENCY,
      AMOUNTINTRANSACTIONCURRENCY,
      DEBTOR,
      DEBITCREDITCODE,
      BUSINESSPARTNERNAME
      COUNTRY,
      RECEIVABLEKEY
    ]
  }
}
```

### Listing 6: Example Set of Metrics from LLM

In some implementations, training of the global ML model 320 can be executed using the training data 314 and the set of metrics 340. In some examples, the training data includes a query document 314a, a target document 314b, and example matches 314c. In some examples, the query document 314a includes query items (e.g., bank statement line items) and the target document 314b includes target items (e.g., line items representing invoices). The example matches 314c indicates matches between each query item of the query document 314a to one or more target items of the target document 314b and, for each match, a type of match (e.g., 1-to-1, 1-to-many).

In accordance with implementations of the present disclosure, the filter pre-processing module 306 filters one or more data fields from each of the query document 314a and the target document 314b to provide a query document 314a′ and a target document 314b′, respectively. In some examples, the set of metrics 340 includes a first sub-set of metrics (data fields) to be applied to query documents and a second sub-set of metrics (data fields) to be applied to target documents. In some examples, the filter pre-processing module 306 compares the first sub-set of metrics to the query document 314a and any data field that is in the query document 314a, but is absent from the first sub-set of metrics is deleted from the query document 314a to provide the query document 314a′ (e.g., if the query document 314a includes a column PARTNERBANK, but the column PARTNERBANK is not included in the first sub-set of metrics, the column PARTNERBANK is deleted from the query document 314a, to provide the query document 314a′). In this manner, the query document 314a′ includes less data than the query document 314a. In some examples, the filter pre-processing module 306 compares the second sub-set of metrics to the target document 314b and any data field that is in the target document 314b, but is absent from the second sub-set of metrics is deleted from the target document 314b to provide the target document 314b′. In this manner, the target document 314b′ includes less data than the target document 314b.

In some implementations, the query document 314a′ is processed by the query processing module 310 to replace any unstructured data with structured data. More particularly, query documents (e.g., the query document 314a, the query document 314a′) can include heterogeneous, semi-structured data. Here, heterogeneous refers to mixed data types (e.g., numerical, categorical, textual). Example structured data can include tabular data that is recorded in columns and rows of a table. For example, each column represents a data field and a respective data type and each row represents a respective record recorded in the table. Example semi-structured data can include introduction of unstructured data within structured data. For example, a column of a table can store text data, which is unstructured (e.g., free-form text). Here, while the table itself is generally considered structured, content stored within the data can be unstructured. In the example context of bank statements, MEMOLINE is a data field that includes unstructured text data. As described in further detail herein, the unstructured data processing module 304 is used to replace any unstructured data within the query document 314a′ with structured data.

In further detail, the query processing module 310 includes a data splitter 350 and a data merger 352. In some examples, the data splitter 350 splits the query document 314a′ into structured data 360 and unstructured data 362. In some examples, the data splitter 350 splits the query document 314a′ based on data types of respective data fields (columns). For example, data fields having numerical and categorical data types can record structured data, while data fields having the textual data type can record unstructured data. In some examples, the structured data 360 includes a first sub-set of data fields of the query document 314a′ and the unstructured data 362 includes a second sub-set of data fields of the query document 314a′.

In accordance with implementations of the present disclosure, the unstructured data processing module 304 processes the unstructured data 362 to provide a set of property-value pairs 364. More particularly, the unstructured data processing module 304 includes an unstructured data processing agent 304a that leverages a LLM of one or more LLM systems 322 (e.g., GPT-4 provided by OpenAI). As such, the unstructured data processing agent 304a can be referred to as a LLM-based agent. In some examples, the unstructured data processing agent 304a is provided as a conversational agent that a user can converse with in natural language (e.g., Joule provided by SAP SE of Walldorf, Germany, introduced above). In some examples, the domain knowledge analysis agent 302a and the unstructured data processing agent 304a are separate and distinct LLM-based agents. In some examples, the domain knowledge analysis agent 302a and the unstructured data processing agent 304a are the same LLM-based agent.

In some implementations, the unstructured data processing agent 304a leverages the LLM(s) to interpret the data fields of the of the query document 314a′ (e.g., the unstructured data 362). In some examples, the unstructured data processing agent 304a uses the data schema description 330 and the task description 332. For example, the unstructured data processing agent 304a incorporates the unstructured data (e.g., memoline) in the context of the task and the data schema of the target document to abstract the possibles values that are relevant to the respective data field in the target documents. Further, the unstructured data processing agent 304a provides a mapping between the value and the data field in a unstructured data mapping 304b (stored in memory).

In some examples, the unstructured data processing agent 304a prompts the LLM system(s) 322 using a prompt, the LLM system(s) processes the prompt and returns the set of property-value pairs 364. In some examples, the prompt is constructed to enable the LLM(s) to abstract any value in the unstructured data that helps identify matching relations. In some examples, the prompt can be provided as a CoT prompt. In the non-limiting context of matching line items of a bank statement table to one or more line items of an invoice table, the following example prompt can be provided for training:

Evaluate free text in memo line with below steps:
1. Understand the memo line {Memoline} based on the task
objective {TaskObjective} and enterprise process
{EnterpriseProcess}.
2. Look for any part of memoline which is the same as or has
the same meaning as any value of attribute in open invoice
{OpenInvoiceltem}.
3. Output the identified part in a JSON format as below:
′{
{attributeName}: {identifiedPart}
}′

### Listing 7: Example Prompt (Training)

In some implementations, the data merger 352 merges the structured data 360 with the set of property-value pairs 364 to provide a query document 314a″ that includes only structured data. In some examples, the set of property-value pairs 364 (e.g., in JSON format) can be serialized into a column-based dataframe (i.e. all of “identifiedPart” by rows under “attributeName”). The column-based dataframe can be concatenated with the structured data by column into a merged table.

In some implementations, consolidated training data 370 is provided and includes the query document 314a″, the target document 314b′, and the example matches 314c. The consolidated training data 370 is provided to the training module 312, which executes training of the global ML model 320. In general, the global ML model 320 is iteratively trained, where, during an iteration, also referred to as epoch, one or more parameters of the global ML model 320 are adjusted, and an output is generated based on the training data (e.g., class predictions). For each iteration, a loss value is determined based on a loss function. The loss value represents a degree of accuracy of the output of the global ML model 320. The loss value can be described as a representation of a degree of difference between the output of the global ML model 320 and an expected output of the global ML model 320 (e.g., provided in the example matches 314c). In some examples, if the loss value does not meet an expected value (e.g., is not equal to zero), parameters of the global ML model 320 are adjusted in another iteration (epoch) of training. In some examples, the iterative training continues for a pre-defined number of iterations (epochs). In some examples, the iterative training continues until the loss value meets the expected value or is within a threshold range of the expected value. Upon completion of training, the global ML model 320 is deployed for inference.

FIG. 3B depicts an example conceptual architecture 300′ for inference in accordance with implementations of the present disclosure. In the example of FIG. 3B, the conceptual architecture 300′ includes the schema metrics module 302, the unstructured data processing module 304, the filter pre-processing module 306, a target filtering module 308, the query processing module 310, and an inference module 318. As described in further detail herein, at least a portion of inference data 380 is used to generate an inference result 390 using the global ML model 320. In some examples, the inference data 380 includes data that was not used for training. In some examples, the inference data 380 represents data relations that were absent from representation within the training data 314

Before executing inference over the inference data 380, the domain knowledge analysis agent 302a functions to leverage domain knowledge to enable data fields determined to be irrelevant to the matching task to be filtered from the inference data 380. More particularly, the domain knowledge analysis agent 302a can receive a data schema description 330′, a task description 332′, and a set of example matches 334′ that are collectively descriptive of the matching task and data that is to be matched, as similarly described above. The domain knowledge analysis agent 302a prompts (e.g., using the example prompt of Listing 5) the one or more LLM systems 322 based on the data schema description 330′, the task description 332′, and the set of example matches 334′ to provide a set of metrics 340′. In some examples, the set of metrics 340′ can include a list of data fields (which can be referred to as global ML model schema metrics) that are relevant to the matching task. In some examples, the set of metrics 340′ includes one or more data fields of a query document (e.g., bank statement table) and one or more data fields of a target document (e.g., invoice table).

It can be noted that the data schema description 330′ and the set of example matches 334′ are specific to the inference data 380 and are distinct from the data schema description 330 and the set of example matches 334 used during training. For example, the data schema description 330 and the set of example matches 334 used during training can be representative of those of a first enterprise, while the data schema description 330′ and the set of example matches 334′ used during inference can be representative of those of a second enterprise.

In accordance with implementations of the present disclosure, the filter pre-processing module 306 filters one or more data fields from each of a query document 380a and a target document 380b to provide a query document 380a′ and a target document 380b′, respectively. In some examples, the set of metrics 340′ includes a first sub-set of metrics (data fields) to be applied to query documents and a second sub-set of metrics (data fields) to be applied to target documents. In some examples, the filter pre-processing module 306 compares the first sub-set of metrics to the query document 380a and any data field that is in the query document 380a, but is absent from the first sub-set of metrics is deleted from the query document 380a to provide the query document 380a′. In this manner, the query document 380a′ includes less data than the query document 380a. In some examples, the filter pre-processing module 306 compares the second sub-set of metrics to the target document 380b and any data field that is in the target document 380b, but is absent from the second sub-set of metrics is deleted from the target document 380b to provide the target document 380b′. In this manner, the target document 380b′ includes less data than the target document 380b.

In some implementations, the query document 380a′ is processed by the query processing module 310 to replace any unstructured data with structured data, as described herein with reference to FIG. 3A. For example, the data splitter 350 splits the query document 380a′ into structured data 360′ and unstructured data 362′, where the structured data 360′ includes a first sub-set of data fields of the query document 380a′ and the unstructured data 362′ includes a second sub-set of data fields of the query document 380a′.

In accordance with implementations of the present disclosure, the unstructured data processing module 304 processes the unstructured data 362′ to provide a set of property-value pairs 364′. More particularly, and as similarly described herein with reference to FIG. 3A, the unstructured data processing agent 304a prompts the LLM system(s) 322 using a prompt, the LLM system(s) processes the prompt and returns a set of property-value pairs 364′. In the non-limiting context of matching line items of a bank statement table to one or more line items of an invoice table, the following example prompt can be provided for inference:

Evaluate free text in memo line with be low steps:
1. Understand the memo line {Memoline} based on the task
objective {TaskObjective} and enterprise process
{EnterpriseProcess}.
2. Look for any part of memoline which is the same as or has
the same meaning as any value of attribute in open invoice
{OpeninvoiceTable}.
3. Look for any part of memoline which has the same identified
part from memo matching mappings {MemoMappings}.
4. Output the identified part in a JSON format as below:
′{
{attributeName}: {identifiedPart}
}′

### Listing 8: Example Prompt (Inference)

Here, the example prompt induces the UD mappings 304b ({MemoMappings}) to identify and abstract any value in a respective data field (e.g., memoline) that is matched to any property in any target item. In some implementations, the data merger 352 merges the structured data 360′ with the set of property-value pairs 364′ to provide a query document 380a″ that includes only structured data.

In some implementations, the target document 380b′ is processed by the target filtering module 308 to provide a target document 380b″. In some examples, the target filtering module 308 uses a retrieval augmented generation (RAG) service, which performs embedding generation and similarity search. By embedding generation, the target document 380b′ is processed to generate a target document embedding database (e.g., open invoices). This happens at the time of uploading target documents to data storage. At the time of inference, properties of query line items (e.g., company code, company name) are used to narrow down the relevant target line items through similarity search in target document embedding database. In this manner, relevant target documents can be identified and irrelevant filtered out.

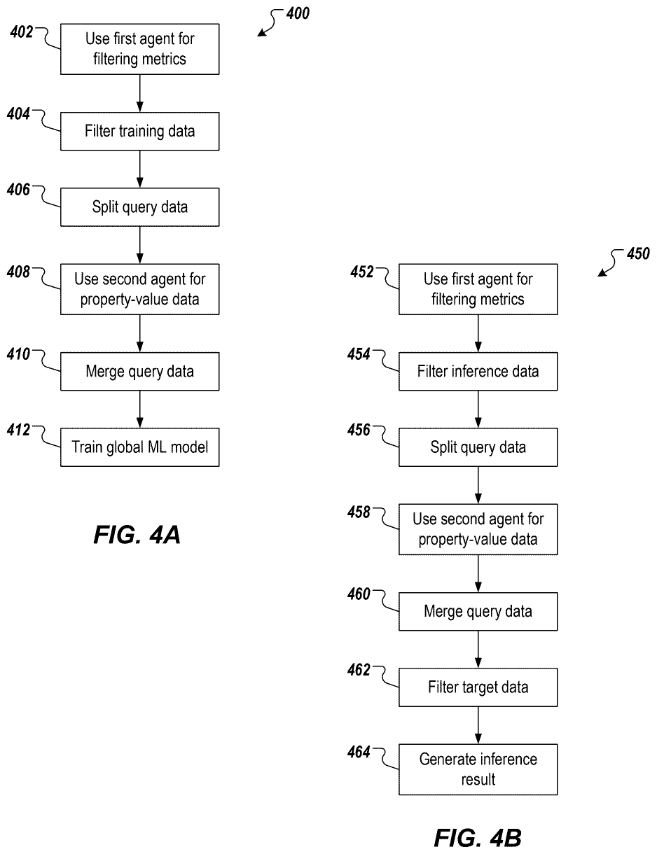

FIG. 4A depicts an example process 400 that can be executed in accordance with implementations of the present disclosure. In some examples, the example process 400 is provided using one or more computer-executable programs executed by one or more computing devices.

A first agent is used for filtering metrics (402). For example, and as described in detail herein with reference to FIG. 3A, the domain knowledge analysis agent 302a can receive a data schema description 330, a task description 332, and a set of example matches 334 (e.g., from a user) and prompts the one or more LLM systems 322 based on the data schema description 330, the task description 332, and the set of example matches 334, the one or more LLM systems returning a set of metrics 340 responsive to the prompt. Training data is filtered (404). For example, and as described in detail herein, the filter pre-processing module 306 filters one or more data fields from each of the query document 314a and the target document 314b to provide a query document 314a′ and a target document 314b′, respectively, by comparing data fields of the query document 314a and the target document 314b to data fields provided in the set of metrics 340.

Query data is split (406). For example, and as described in detail herein, the data splitter 350 splits the query document 314a′ into structured data 360 and unstructured data 362 based on data types of respective data fields (columns). A second agent is used for property-value data (408). For example, and as described in detail herein, the unstructured data processing agent 304a prompts the LLM system(s) 322 using a prompt that is provided based on the unstructured data 362, the LLM system(s) processes the prompt and returns the set of property-value pairs 364. Query data is merged (410). For example, and as described in detail herein, the data merger 352 merges the structured data 360 with the set of property-value pairs 364 to provide a query document 314a″ that includes only structured data.

A global ML model is trained (412). For example, and as described in detail herein, consolidated training data 370 is provided and includes the query document 314a″, the target document 314b′, and the example matches 314c. The consolidated training data 370 is provided to the training module 312, which executes training of the global ML model 320.

FIG. 4B depicts an example process 450 that can be executed in accordance with implementations of the present disclosure. In some examples, the example process 450 is provided using one or more computer-executable programs executed by one or more computing devices.

A first agent is used for filtering metrics (452). For example, and as described in detail herein with reference to FIG. 3B, the domain knowledge analysis agent 302a can receive a data schema description 330′, a task description 332′, and a set of example matches 334′ (e.g., from a user) and prompts the one or more LLM systems 322 based on the data schema description 330′, the task description 332′, and the set of example matches 334′, the one or more LLM systems returning a set of metrics 340′ responsive to the prompt. Inference data is filtered (454). For example, and as described in detail herein, the filter pre-processing module 306 filters one or more data fields from each of the query document 380a and the target document 380b to provide a query document 380a′ and a target document 380b′, respectively, by comparing data fields of the query document 380a and the target document 380b to data fields provided in the set of metrics 340′.

Query data is split (456). For example, and as described in detail herein, the data splitter 350 splits the query document 380a′ into structured data 360′ and unstructured data 362′ based on data types of respective data fields (columns). A second agent is used for providing property-value pairs (458). For example, and as described in detail herein, the unstructured data processing agent 304a prompts the LLM system(s) 322 using a prompt that is provided based on the unstructured data 362′, the LLM system(s) processes the prompt and returns the set of property-value pairs 364′. Query data is merged (460). For example, and as described in detail herein, the data merger 352 merges the structured data 360′ with the set of property-value pairs 364′ to provide a query document 380a″ that includes only structured data.

Target data is filtered (462) and an inference result is generated (464). For example, and as described herein, the global ML model 320 processes the query document 380a″ and the target document 380b″ to generate the inference result 390.

As described in detail herein, implementations of the present disclosure provide a set of LLM-based agents that are used for training of a global ML model and inference using the global ML model. In some implementations, a first LLM-based agent (e.g., the domain knowledge analysis agent 302a of FIGS. 3A and 3B) leverages one or more LLMs to help abstract generic and core data fields as global schema metrics relevant for matching entities using the global ML model and mitigating the degrading impact of noisy data fields and varying data fields have on inference using the global ML model. In some implementations, a second LLM-based agent (e.g., the unstructured data processing agent 304a of FIGS. 3A and 3B) leverages one or more LLMs to achieve accurate data abstraction for unstructured data fields, thereby enhancing performance of training of the global ML model and inference using the global ML model. As also described herein, implementations of the present disclosure builds data mappings as a data source for unstructured data processing, from training data and ongoing inference data. This approach can improve the accuracy and adaptivity of the global ML model.

As described in detail herein, implementations of the present disclosure provide multiple technical improvements. For example, implementations of the present disclosure abstract efficient and common data sets for training of the global ML model based on task and process knowledge and data relations. In this manner, the global ML model is usable for any enterprise under the same domain scenario (e.g., matching bank statement line items to invoice line items). In this manner, the need for multiple, enterprise-specific ML models is obviated, thereby conserving technical resources. As another example, implementations of the present disclosure reduce the volume of training data used for training the global ML model, thereby conserving technical resources. As another example, implementations of the present disclosure reduce the volume of inference data processed by the global ML model, thereby conserving technical resources. As still other examples, implementations of the present disclosure improve inference accuracy of the global ML model and obviates fine-tuning.

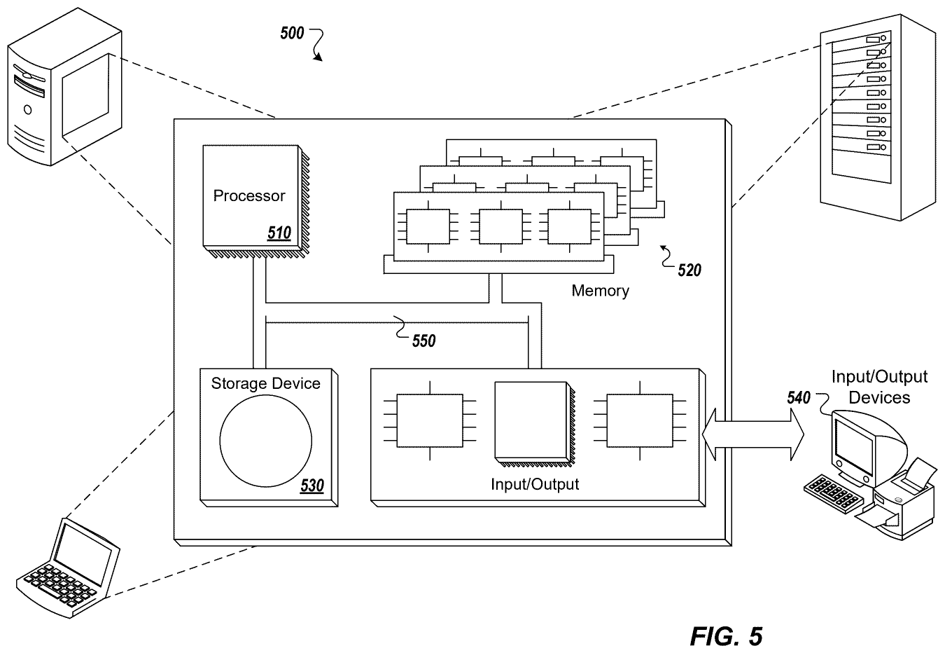

Referring now to FIG. 5, a schematic diagram of an example computing system 500 is provided. The system 500 can be used for the operations described in association with the implementations described herein. For example, the system 500 may be included in any or all of the server components discussed herein. The system 500 includes a processor 510, a memory 520, a storage device 530, and an input/output device 540. The components 510, 520, 530, 540 are interconnected using a system bus 550. The processor 510 is capable of processing instructions for execution within the system 500. In some implementations, the processor 510 is a single-threaded processor. In some implementations, the processor 510 is a multi-threaded processor. The processor 510 is capable of processing instructions stored in the memory 520 or on the storage device 530 to display graphical information for a user interface on the input/output device 540.

The memory 520 stores information within the system 500. In some implementations, the memory 520 is a computer-readable medium. In some implementations, the memory 520 is a volatile memory unit. In some implementations, the memory 520 is a non-volatile memory unit. The storage device 530 is capable of providing mass storage for the system 500. In some implementations, the storage device 530 is a computer-readable medium. In some implementations, the storage device 530 may be a floppy disk device, a hard disk device, an optical disk device, or a tape device. The input/output device 540 provides input/output operations for the system 500. In some implementations, the input/output device 540 includes a keyboard and/or pointing device. In some implementations, the input/output device 540 includes a display unit for displaying graphical user interfaces.

The features described can be implemented in digital electronic circuitry, or in computer hardware, firmware, software, or in combinations thereof. The apparatus can be implemented in a computer program product tangibly embodied in an information carrier (e.g., in a machine-readable storage device, for execution by a programmable processor), and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

1. A computer-implemented method for training and deploying a global machine learning (ML) model for line-item matching between documents using large language models (LLMs), the method being executed by one or more processors and comprising:
receiving, by a first LLM-based agent, a data schema description, a task description, and a set of examples, the data schema description comprising a description of a data schema of a query document and a data schema of a target document, the task description describes an objective of data relation identification;
prompting, by the first LLM-based agent, a first LLM using a first prompt that is provided based on the data schema description, the task description, and the set of examples, the first LLM returning a set of metrics responsive to the first prompt;
filtering data from the query document and data from the target document using the set of metrics;
prompting, by a second LLM-based agent, a second LLM using a second prompt that is provided based on unstructured data of the query document, the second LLM returning a set of property-value pairs responsive to the second prompt;
providing a merged query document based on the property-value pairs; and
processing the merged query document and the target document using a global ML model to generate a set of results.

2. The method of claim 1, wherein the set of metrics comprises data fields determined to be relevant to a task executed by the global ML model.

3. The method of claim 1, further comprising splitting data of the query document into a first sub-set and a second sub-set, the first sub-set comprising structured data, and the second sub-set comprising the unstructured data.

4. The method of claim 1, wherein the query document records structured data and unstructured data and the merged query document records only structured data.

5. The method of claim 1, further comprising receiving, by the second LLM-based agent, the data schema description and the task description, the second prompt further being provided based on the data schema description and the task description.

6. The method of claim 1, further comprising maintaining an unstructured data mapping based on responses from the second LLM for training of the global ML model.

7. The method of claim 6, wherein the second prompt is further provided based on the unstructured data mappings for inference using the global ML model.

8. The method of claim 1, wherein the processing the merged query document and the target document using a global ML model to generate a set of results is executed for training of the global ML model.

9. The method of claim 1, wherein the processing the merged query document and the target document using a global ML model to generate a set of results is executed for inference using the global ML model after training of the global ML model.

10. A non-transitory computer-readable storage medium coupled to one or more processors and having instructions stored thereon which, when executed by the one or more processors, cause the one or more processors to perform operations for training and deploying a global machine learning (ML) model for line-item matching between documents using large language models (LLMs), the operations comprising:
receiving, by a first LLM-based agent, a data schema description, a task description, and a set of examples, the data schema description comprising a description of a data schema of a query document and a data schema of a target document, the task description describes an objective of data relation identification;
prompting, by the first LLM-based agent, a first LLM using a first prompt that is provided based on the data schema description, the task description, and the set of examples, the first LLM returning a set of metrics responsive to the first prompt;
filtering data from the query document and data from the target document using the set of metrics;
prompting, by a second LLM-based agent, a second LLM using a second prompt that is provided based on unstructured data of the query document, the second LLM returning a set of property-value pairs responsive to the second prompt;
providing a merged query document based on the property-value pairs; and
processing the merged query document and the target document using a global ML model to generate a set of results.

11. The non-transitory computer-readable storage medium of claim 10, wherein the set of metrics comprises data fields determined to be relevant to a task executed by the global ML model.

12. The non-transitory computer-readable storage medium of claim 10, wherein operations further comprise splitting data of the query document into a first sub-set and a second sub-set, the first sub-set comprising structured data, and the second sub-set comprising the unstructured data.

13. The non-transitory computer-readable storage medium of claim 10, wherein the query document records structured data and unstructured data and the merged query document records only structured data.

14. The non-transitory computer-readable storage medium of claim 10, wherein operations further comprise receiving, by the second LLM-based agent, the data schema description and the task description, the second prompt further being provided based on the data schema description and the task description.

15. The non-transitory computer-readable storage medium of claim 10, wherein operations further comprise maintaining an unstructured data mapping based on responses from the second LLM for training of the global ML model.

16. A system, comprising:
a computing device; and
a computer-readable storage device coupled to the computing device and having instructions stored thereon which, when executed by the computing device, cause the computing device to perform operations for training and deploying a global machine learning (ML) model for line-item matching between documents using large language models (LLMs), the operations comprising:
receiving, by a first LLM-based agent, a data schema description, a task description, and a set of examples, the data schema description comprising a description of a data schema of a query document and a data schema of a target document, the task description describes an objective of data relation identification;
prompting, by the first LLM-based agent, a first LLM using a first prompt that is provided based on the data schema description, the task description, and the set of examples, the first LLM returning a set of metrics responsive to the first prompt;
filtering data from the query document and data from the target document using the set of metrics;
prompting, by a second LLM-based agent, a second LLM using a second prompt that is provided based on unstructured data of the query document, the second LLM returning a set of property-value pairs responsive to the second prompt;
providing a merged query document based on the property-value pairs; and
processing the merged query document and the target document using a global ML model to generate a set of results.

17. The system of claim 16, wherein the set of metrics comprises data fields determined to be relevant to a task executed by the global ML model.

18. The system of claim 16, wherein operations further comprise splitting data of the query document into a first sub-set and a second sub-set, the first sub-set comprising structured data, and the second sub-set comprising the unstructured data.

19. The system of claim 16, wherein the query document records structured data and unstructured data and the merged query document records only structured data.

20. The system of claim 16, wherein operations further comprise receiving, by the second LLM-based agent, the data schema description and the task description, the second prompt further being provided based on the data schema description and the task description.
